(19) United States
(12) Patent Application Publication
(10) Pub. No.: US 2019/0036802 A1
(43) Pub. Date: Jan. 31, 2019

(54) SYSTEM AND METHOD FOR PACKET TRACING WITHIN A PACKET SWITCHING ASIC

(71) Applicant: Nokia Solutions and Networks Oy, Espoo (FI)

(72) Inventor: Krishna Ram Kuttuva Jeyaram, Milpitas, CA (US)

(21) Appl. No.: 15/659,011

(22) Filed: Jul. 25, 2017

(51) Int. Cl. H04L 12/26

(52) U.S. Cl. CPC H04L 43/10

(57) ABSTRACT

A packet trace device inserts a test packet or packet data into a simulation unit which mimics processing of the packet or packet data by an ASIC in a node. The packet trace device obtains data stored in memory of the ASIC. The packet trace device performs simulation of the functions of the ASIC using the data. The packet trace device then obtains packet tracing information from the simulation. The simulator unit is thus able to use data from the actual ASIC hardware, such as data from tables/registers and provides information on where a packet is dropped or other error occurs.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT Disc

Not applicable.

### BACKGROUND

### Technical Field

This disclosure relates generally to network elements and more particularly, but not exclusively, to systems and methods for packet tracing within an integrated circuit (IC) of a packet switching network element.

### Description of Related Art

The statements in this section provide a description of related art and are not admissions of prior art. Communication networks include many different computing devices, for example, switches, routers, or bridges, to communicate with each other and with various other network elements or user devices attached to the network. For example, communication networks may comprise, without limitation, packet switched networks, such as IP, Metro Ethernet or Enterprise Ethernet networks that support multiple applications including, for example, voice-over-IP (VoIP), data and video applications. Such networks regularly include various types of interconnected packet switching network elements, such as switches or routers, for carrying traffic through the network.

Packet switching network elements often include application specific integrated circuits (ASICs) that are configured for Layer 2 and Layer 3 packet switching, forwarding, and route lookup functions. The packet switching ASICs are located on physical interface cards (PICs) or network interface cards (NIC). Tracing of packets through an ASIC is difficult especially in network elements deployed in a production network carrying real-time data.

A need thus exists for an improved system and method for packet tracing in ASIC based packet switched network elements.

### SUMMARY

In an embodiment, a packet trace device comprises a packet trace utility configured to communicate with a packet switching node deployed in a production network, wherein the packet trace utility receives data related to processing of packets generated by a packet switching ASIC in the node. The packet trace device further includes a simulator unit configured to simulate functions of the packet switching ASIC using the data from the node and obtain packet tracing information from the simulation.

In another embodiment, a method for packet tracing includes accessing a packet switching ASIC in a node, wherein the node is deployed in the production network; obtaining data stored in a memory by the packet switching ASIC, wherein the data is generated in processing of a packet by the packet switching ASIC; simulating functions of the packet switching ASIC using the obtained data from the packet switching ASIC; and generating packet tracing information from simulating the functions.

In still another embodiment, a network management system, comprising a network interface coupled to a plurality of packet switching nodes in a production network and a packet trace device. The packet trace device include a packet trace utility configured to communicate with at least one of the plurality of packet switching nodes, wherein the packet trace utility receives data related to processing of packets generated by a packet switching ASIC in the node. The packet trace device further includes a simulator unit configured to simulate functions of the packet switching ASIC using the data from the node and obtain packet tracing information from the simulation.

In some embodiments of any of the above apparatus/methods, an ASIC abstraction application programming interface (API) is configured to map to a memory of the packet switching ASIC in the node and obtain the data related to processing of packets generated by the packet switching ASIC. The ASIC abstraction API is configured to obtain data from hardware memory tables generated by the packet switching ASIC.

In some embodiments of any of the above apparatus/methods, the simulator unit is configured to operate in a diagnostics mode. When operating in the diagnostics mode, the simulator unit is configured to simulate packet processing of the packet switching ASIC using data from hardware memory tables of the packet switching ASIC and provide one or more log messages on the simulated packet processing at each block of the packet switching ASIC.

In some embodiments of any of the above apparatus/methods, a routing module is configured to simulate forwarding functions of the packet switching ASIC in the node.

In some embodiments of any of the above apparatus/methods, a packet generation module generates packet or packet data to write to one or more memories of the packet switching ASIC.

### BRIEF DESCRIPTION OF THE SEVERAL VIEWS OF THE DRAWINGS

Some embodiments of apparatus and/or methods in accordance with embodiments of the disclosure are now described, by way of example only, and with reference to the accompanying drawings, in which:

FIG. 1 illustrates a schematic block diagram of an embodiment of a packet switching node;

FIG. 2 illustrates a schematic block diagram of an embodiment of a network interface module in more detail;

FIG. 3 illustrates a schematic block diagram of an embodiment of a packet trace device including a simulator unit;

FIG. 4 illustrates a schematic block diagram of a network management system including the packet trace device;

FIG. 5 illustrates a schematic block diagram of an embodiment of a network and a network management system including the packet trace device;

FIG. 6 illustrates a logical flow diagram of an embodiment of a method for packet tracing by the packet trace device;

FIG. 7 illustrates a logical flow diagram of an embodiment of a method for modifying a simulator unit for packet tracing;

FIG. 8 illustrates a schematic block diagram of an embodiment of a simulator unit in more detail.

### DETAILED DESCRIPTION

The description and drawings merely illustrate the principles of various embodiments. It will thus be appreciated that those skilled in the art will be able to devise various arrangements that, although not explicitly described or shown herein, embody the principles herein and in the claims and fall within the spirit and scope of the disclosure. Furthermore, all examples recited herein are principally intended expressly to be only for pedagogical purposes to aid the reader in understanding the principles of the embodiments and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass equivalents thereof.

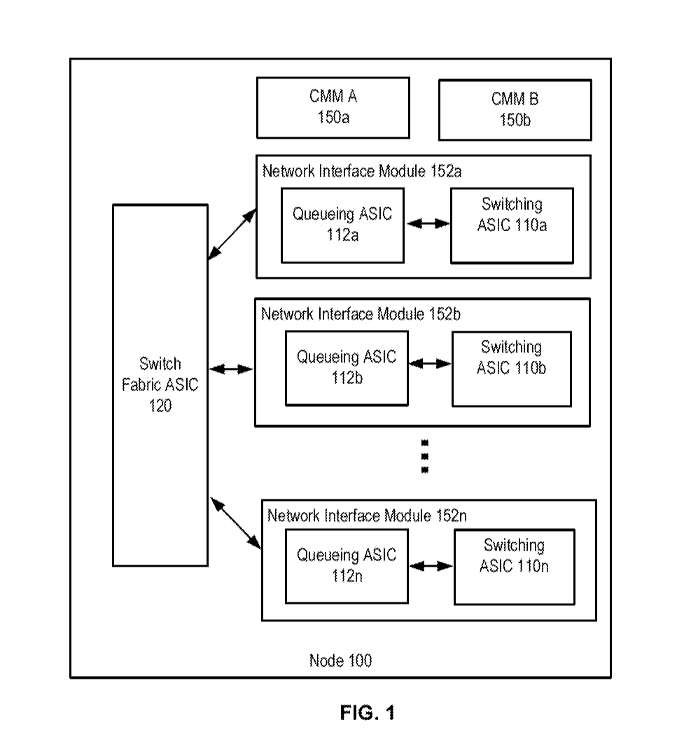

FIG. 1 illustrates a schematic block diagram of an embodiment of a packet switching node 100. This embodiment is only one example and other types of nodes may be implemented herein or other nodes with different architectures and components. In this example, the node 100 includes at least one Chassis Management Module (CMM) module 150a (primary) and preferably a second CMM module 150b (back-up) as well as a plurality of Network Interface modules (NIM) 152, such as line cards or port modules. In an embodiment, the the NIMs 150 include a Switching application specific integrated circuit (ASIC) 110 and a Queuing ASIC 112. A switch fabric ASIC 214 provides an interconnection between the various NIMs 152 in the node 100.

In an embodiment, the Switching ASICs 210 of the network interface module (NIMs) 152 are connected to external nodes through one or more external port interfaces. The Switching ASIC 110 on a NIM 152 receives a packet on an ingress port and determines a destination address of the incoming packet. The packet may be switched to another external port interface of the Switching ASIC 110 for egress or to the Queuing ASIC 112 for transmission to another NIM 152 on node 100. The Queuing ASIC 212 may include a packet buffer and/or a queue management for providing traffic and buffer management. The Queuing ASIC 112 forwards the packet over the Switch Fabric ASIC 120 to another NIM 152. Another Queuing ASIC 112 receives the packet from the Switch Fabric ASIC 120 and places the packet in an egress queue. The Switching ASIC 110 then transmits the packet over an egress port to another node.

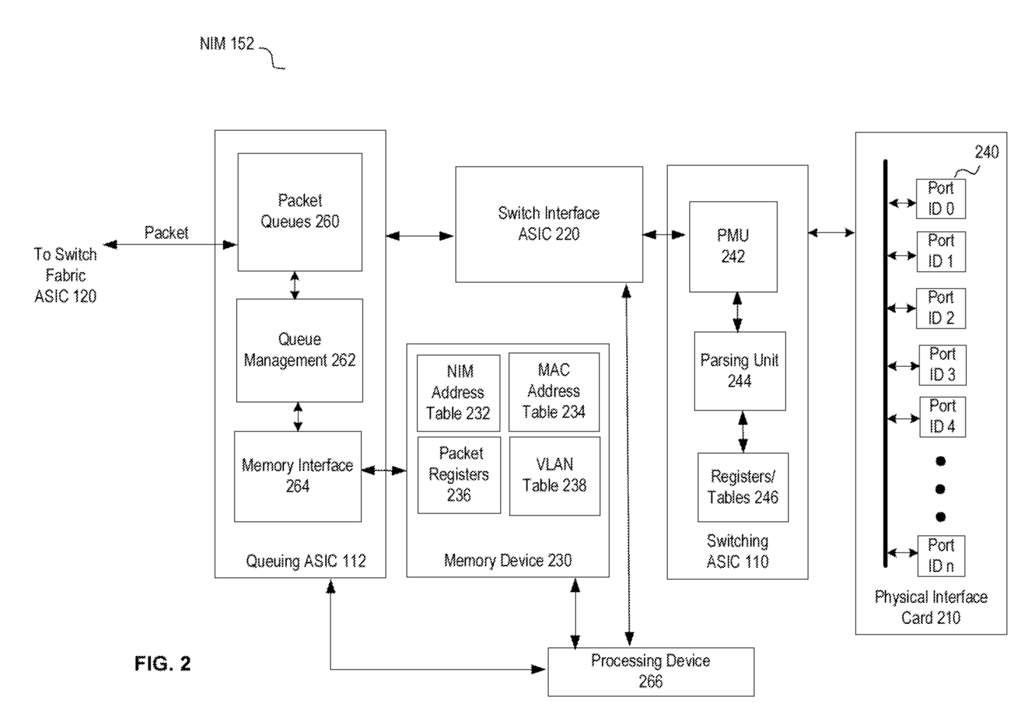

FIG. 2 illustrates a schematic block diagram of an embodiment of a network interface module 152 in more detail. The NIM 152 includes a physical interface card (PIC) 210 with a plurality of external ports 240. The external ports 240 may have the same physical interface type, such as copper ports (CAT-5E/CAT-6), multi-mode fiber ports (SX) or single-mode fiber ports (LX). In another embodiment, the external ports may have one or more different physical interface types.

An ingress packet arrives at an incoming external port 240 of the PIC 210. The PIC 210 passes the packet to the Switching ASIC 110. The Switching ASIC 110 includes, e.g., a packet management unit (PMU) 242, a parsing unit 244 and registers/tables 246. The registers and tables are stored in a memory device, such as a DRAM or other type of memory on the ASIC. The PMU 242 determines a destination for an incoming packet while the parsing unit 244 may parse the packet into smaller cells or units for switching. The switching ASIC performs Layer 2 and Layer 3 parsing and divides the packets into 64-byte cells. The Switching ASIC 210 further includes a packet management unit (PMU) 242 that determines a destination address of incoming packets. The packets may be switched to another external port interface 240 of the Switching ASIC 210, to the Queuing ASIC 212 for transmission to another NIM 152 on the node, or to the processing device. The Switch Interface ASIC extracts a route lookup key, places it in a notification, and passes the notification to the processing device 266.

The Switch Interface ASIC 110 also passes the data cells to the Queuing ASIC 112 for buffering. The Queuing ASIC 212 includes packet buffer 260, a queue management 262 for providing traffic and buffer management and a memory interface 264. The processing device 266 may perform a route lookup and forward a notification to the Queuing ASIC 112. The Queuing ASIC 112 sends the notification to the Switch Interface ASIC 220 facing the switch fabric ASIC 120 unless the destination is on the same NIM 152. In this case, the notification is sent back to the Switch Interface ASIC facing the outgoing ports, and the packets are sent to the outgoing port without passing through the switch fabric.

The Switch Interface ASIC 220 sends bandwidth requests through the switch fabric ASIC 120 to the destination NIM 152. The Switch Interface ASIC 120 also issues read requests to the Queuing ASIC 112 to begin reading data cells out of memory. The destination Switch Interface ASIC 220 sends bandwidth grants through the switch fabric ASIC 120 to the originating Switch Interface ASIC. On receipt of each bandwidth grant, the originating Switch Interface ASIC sends a cell through the switch fabric ASIC 120 to the destination Switching ASIC 110.

The destination NIM 152 receives cells from the switch fabric ASIC 120. It extracts the route lookup key from each cell, places it in a notification, and forwards the notification to the processing device 266. The processing device 266 performs the route lookup, and forwards the notification to the Queuing ASIC 112. The Queuing ASIC 112 forwards the notification, including next-hop information, to the Switch Interface ASIC 220. The Switch Interface ASIC 220 sends read requests to the Queuing ASIC 112 to read the data cells out of memory and passes the cells to the Packet Switching ASIC 110. The Layer Packet Switching ASIC 110 reassembles the data cells into packets, adds Layer 2 encapsulation, and sends the packets to the outgoing PIC interface 210. The outgoing PIC 210 transmits the packet from an egress port 240.

One or more of the Switching ASIC 110, switch interface ASIC 220, processing device 266 and Queuing ASIC 112 may include onboard memory devices and may also access an external memory device 230. The memory device 230 may include one or more address tables, such as a NIM address table 232 or MAC address table 234 or VLAN table 238. The memory device 230 may also include packet registers or other tables and data.

The MAC address table 234 may include one or more tables, such as source trunk map, trunk bitmap table, trunk group tables, VLAN mapping table, etc. In an embodiment, the MAC address table 234 or parts thereof may be located in the Queuing ASIC 112 as well.

Though the switching ASIC 210 and Queuing ASIC 212 are illustrated as separate integrated circuits or modules, one or more functions or components of the ASICs may be included on the other ASIC or combined into an alternate ASIC or otherwise be implemented in one or more integrated circuits.

In network elements including ASIC based packet switching, it is difficult to perform packet tracing. For example, when packets are dropped in a data path, forwarding tables and registers of ASICs involved in the packet switching must be inspected to determine a cause. This type of inspection of nodes deployed in a production network, such as customer deployed switches/routers, is often not possible.

In an embodiment, a simulator unit is employed as part of a packet tracing device able to track packets in nodes having ASIC based packet switching. Simulator units are generally available for nodes with ASIC based packet switching. The simulator units may include an emulator or simulator. For example, a router emulator is used to test the performance or bugs in router hardware and software. The bugs may include clock timings, software instruction sequencing problems, and speed test. Emulation allows developers to inspect real-time interactions between different hardware and software modules. It is also possible to connect real-world stimulus to peripherals and start debugging system behavior. Normally, a simulator is used during the initial stages of development, when the hardware is not available. A simulator is cost effective and the utility is limited to simulating software functional modules, often without the underlying hardware. The roles of a simulator and an emulator usually complement each other, thus providing a total testing environment. The simulator unit described herein may include a simulator and/or emulator.

For example, Graphical Network Simulator-3 (GNS-3®) from GNS3 Technologies Inc. is a network software simulator. It allows the combination of virtual and real devices, used to simulate complex networks. In another example, Nokia produces a product called a Virtualized Service Router—Simulator (VSR-SIM™). The Nokia VSR-SIM simulates the control, management, and forwarding functions of a Nokia 7750 Service Router (SR) or 7950 XRS muter. The VSR-SIM runs the same service router operating system (SR OS) as on the Nokia 7750 SR and 7950 XRS hardware-based routers and has a same feature set and operational behavior. Configuration of interface, network protocols, and services is performed similarly as with the Nokia 7750 SR and 7950 XRS system. The Nokia VSR-SIM software supports most features and functions of the 7750 SR or 7950 XRS router that is being emulated, including:
IPv4 and IPv6 unicast and multicast forwarding and dependencies on protocols such as ARP, IPv6 neighbor discovery, ICMPv4, ICMPv6, IGMP, and PIM
Layer 3 muting protocols such as BGP, OSPF, and IS-IS
MPLS features such as LDP, RSVP, DS-TE, LDP-over-RSVP, BGP-3107, 6PE and MPLS shortcuts
OAM features such as BFD, IP ping and traceroute, LSP ping and traceroute, Ethernet OAM (CFM and PM), and TWAMP
SAP, network, and subscriber interfaces with relevant statistics
MAC and IP filters (ACLs)
Layer 2 and Layer 3 services including VLL, VPLS, VPRN, and MVPN, along with inter-AS support
QoS features including classification, marking, and policing
management features including Telnet, SSH, SNMP, and Netconf
   The Nokia VSR-SIM is suitable for trials, training, and education, and network simulation. It is optimized for testing and lab environments, but is not intended for deployment in a production network.

In an embodiment, an existing simulator unit developed for testing and lab environments is modified for packet tracing of a node deployed in a production environment, wherein the node includes ASIC based packet switching.

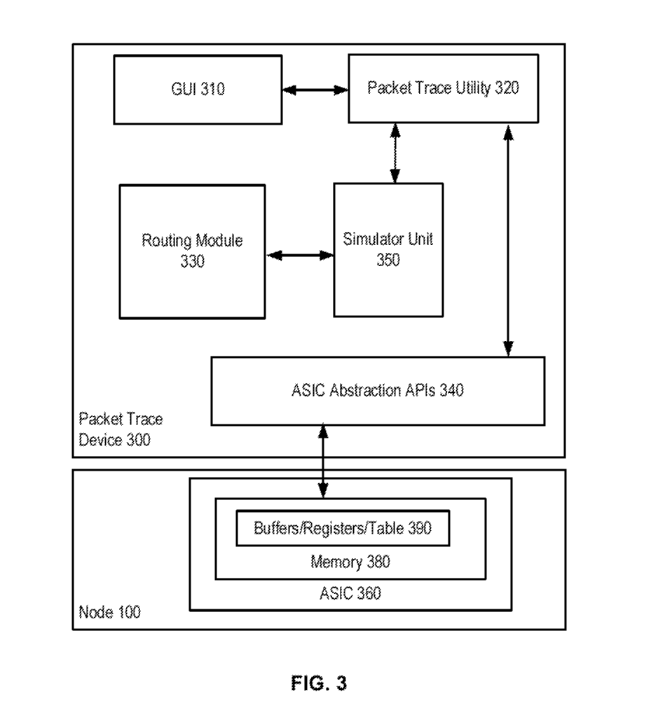

FIG. 3 illustrates a schematic block diagram of an embodiment of a packet trace device 300 including a simulator unit 350. A packet based switching ASIC's functionality is simulated by the simulator unit 350. In an embodiment, the simulator unit 350 includes a simulator developed for testing and lab environments, such as GNS-3® from GNS3 Technologies Inc. or Nokia VSR-SIM™. The simulator unit 350 is modified for packet tracing of a node deployed in a production environment. For example, the packet trace device 300 includes ASIC Abstraction APIs 340. The ASIC Abstraction APIs 340 are configured to map to a memory of one or more ASICs used in packet switching of a node 100. The ASIC memory device 360 may include one or more registers and/or tables 380.

The routing module 330 is configured to provide simulation of the specific node 100 and may be included as a component of the simulator unit 350 or as separate module thereof. For example, the routing module 330 simulates forwarding functions or other operations of the packet processing of the underlying ASIC 360. The packet trace device 300 may thus be used for tracing a packet in the ASIC 360 in the node 100.

The packet trace device 300 traces the packet using the simulator unit 350 and packet trace utility 320. The packet trace utility 320 interfaces with the ASIC 360 using the ASIC abstraction APIs 340. The packet trace utility 320 then provides a stream of buffers associated with an ingress port as input to the simulator unit 350. This buffer represents a packet with a custom Ethernet and IP headers. The simulator unit 350 performs in a diagnostic mode to simulate forwarding of the underlying ASIC using the hardware memory tables obtained through the ASIC abstraction APIs 340. In the course of action, the simulator unit 350 may provide one or more log messages on processing of the packet at each block of the ASIC 360. The simulator unit 350 provides routing decisions by the ASIC 360 with respect to the packet. The simulator unit 350 rewrites packet information in the log messages.

A graphical user interface (GUI) 310 is configured to receive user input and provide output data. The GUI 310 provides an interface for an entity (such as a user) to configure operational parameters for the packet trace device 300. The parameters may be set interactively using the graphical user interface or alternatively, programmatically using an application programming interface (API). For example, the packet trace utility 320 may receive input from the GUI 310 to trace a packet in a format such as “in_port=10, src_mac=00:01:02:03:04:05, dst_mac=00:01:02:03:04:06, etype=0×800, ipv4_src=10.0.0.1, ipv4_dst=20.0.0.1”. The packet trace utility 320 then receives packet tracing information of the packet through the data path of the ASIC 360. The packet tracing information is displayed on the GUI 310.

The packet trace utility 320 may thus obtain packet tracing information to determine how a packet is processed by the simulated ASIC 360 and determine a reason the packet is dropped or how it is processed or egresses through the simulated ASIC. The packet trace device 300 may be used to trace packets in nodes 100 deployed in a production network. The packet trace device 300 may include any type of processing device, such as a server, personal computer, or may be implemented in part within the node 100 itself.

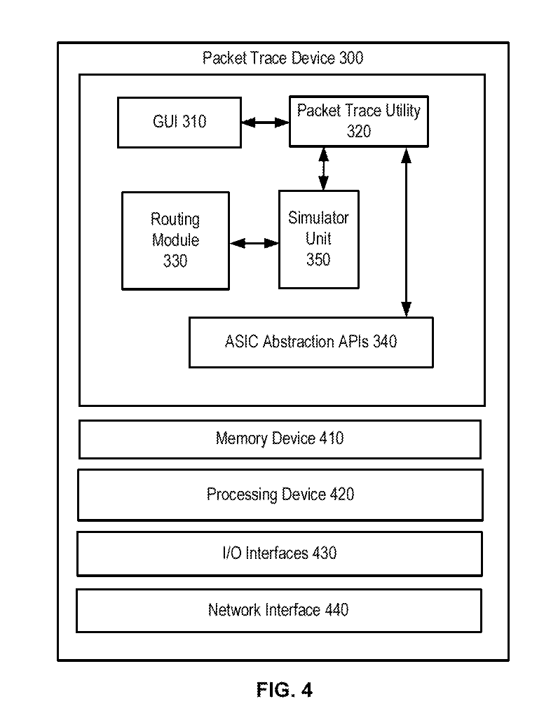

FIG. 4 illustrates a schematic block diagram of the packet trace device 300 in more detail. The packet trace device 300 includes a memory device 410 and a processing device 420. The packet trace device 300 also includes I/O interfaces 430 and a network interface 440. The packet trace device 300 may include any type of processing device, such as a server or personal computer. The I/O interfaces 430 include one or more devices for receiving data from and outputting data to one or more network operators. I/O interfaces 430 may include a display, keyboard, mouse, touchscreen, etc. The memory device 410 includes data storage and operating system.

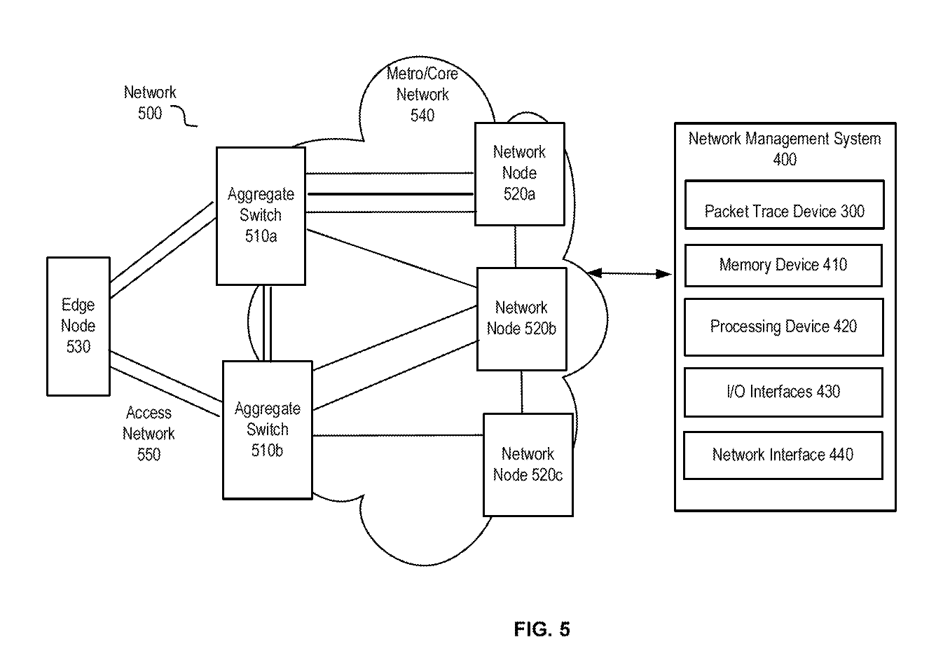

FIG. 5 illustrates a schematic block diagram of an embodiment of a network 500 and a network management system 400 including the packet trace device 300. In an embodiment, the network 500 is a live or production network that carries real-time customer data. The network 500 includes a plurality of nodes 100, including network nodes 520a, 520b, 520c, aggregate switches 510a, 510b and edge node 530.

The various nodes are often distinguished based on their location within particular areas of the network 500, commonly characterizing two or three “tiers” or “layers,” depending on the size of the network. Conventionally, a three tier network consists of an edge layer, an aggregation layer and a core layer (whereas a two tier network consists of only an edge layer and core layer). The edge layer of data networks includes edge or access networks 550 that typically provide connectivity from an Enterprise network or home network, such as a local area network, to a metro or core network 540. The edge nodes 530 are generally connected to an aggregate layer that terminates access links coming from multiple edge nodes. Switches residing at the aggregation layer are known as Aggregate Switches 510. Aggregate Switches 510 may perform, for example, L2 switching and L3 routing of traffic received via the aggregate links from the edge nodes 530. The aggregate layer is connected to a metro or core network 540 layer that performs Layer 3/IP routing of traffic received from the Aggregate Switches 510 (in a three tier network) or from edge nodes 530 (in a two tier network). The Aggregate Switches 510 are also connected to a metro or core network 540 that includes Network Nodes 520, such as network switches and/or routers.

The network 500 is a production network that transmits real-time data. For example, the network 500 may be a service provider network. The NMS 400 communicates with the nodes 100 in the network 500, and the packet trace device 300 is able to perform packet tracing on the nodes 100 in the production network 500. Preferably, the nodes 100 may be placed in standby during the packet tracing process.

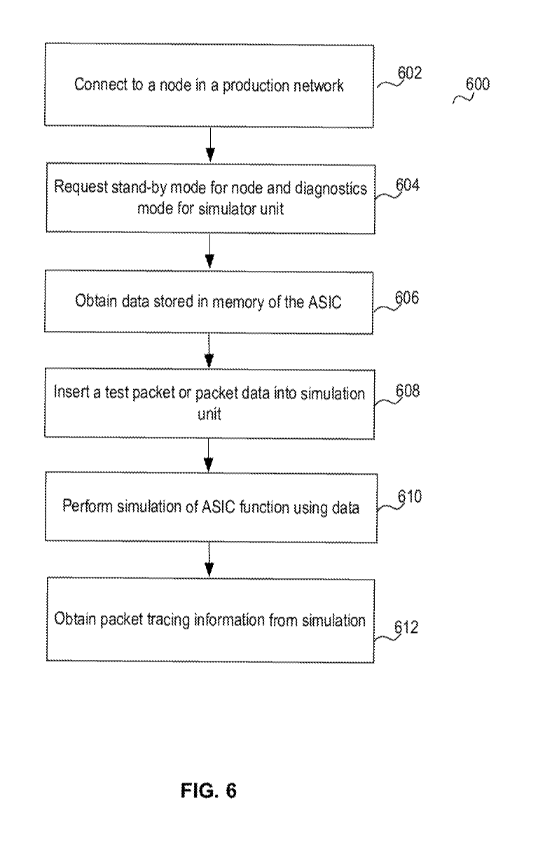

FIG. 6 illustrates a logical flow diagram of an embodiment of a method 600 for packet tracing by the packet trace device 300. The packet trace device 300 connects to a node deployed in a production network at 602. The packet trace device 300 or NMS 400 commands or places the node in a stand-by mode at 604. In addition, the simulation unit 350 may be placed in a diagnostics mode.

The packet trace device 300 obtains data stored in memory of the ASIC at 606. The packet trace device 300 inserts a test packet or packet data into simulation unit which mimics processing of the packet or packet data by an ASIC in the node at 608. The packet trace device 300 performs simulation of the functions of the ASIC using the data at 610. For example, the simulation unit mimics processing of the packet or packet data by the ASIC in the node. The packet trace device 300 then obtains packet tracing information from the simulation at 612.

The simulator unit 350 is thus able to use data from the actual ASIC hardware, such as data from tables/registers and provide information on where a packet is dropped or other error that may occur within the ASIC. In the diagnostic mode, the simulator unit 350 is preferably configured to prevent modifying the ASIC hardware tables themselves and not to forward test packets.

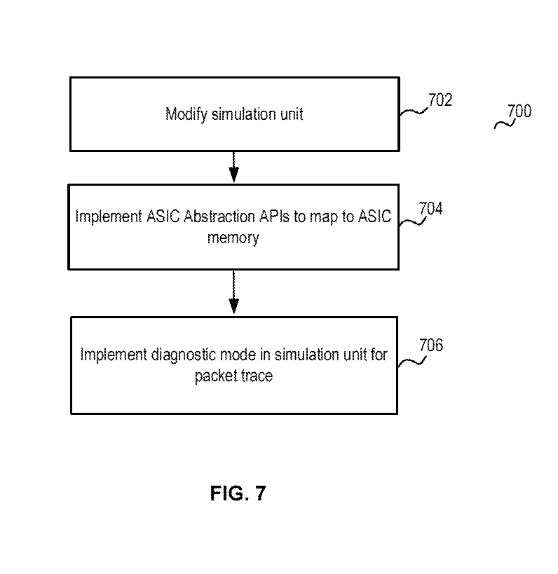

FIG. 7 illustrates a logical flow diagram of an embodiment of a method 700 for modifying a simulator unit 350 for packet tracing. The simulator unit 350 includes an existing simulator unit 350 such as the Graphical Network Simulator-3 (GNS-3®) from GNS3 Technologies Inc. or the Nokia Virtualized Service Router—Simulator (VSR-SIM™). The simulator unit 350 also may be a custom network simulator or other simulator/emulator. The simulator unit 350 may include simulation and/or emulator functions. The existing simulator unit 350 requires adaptations to perform packet tracing functions. The simulator unit 350 is modified at 702. For example, the simulator unit 350 is modified to include ASIC abstraction APIs 340 to map to an ASIC memory of a node 100 in a production network 500 at 704. The simulator unit 350 thus obtains data from the ASIC memory, such as registers, buffers, tables, aging timers, etc. The simulator unit 350 modifies packets or data and transmits the packets through an egress interface of the ASIC. In an embodiment, the simulation unit 350 is modified to include a diagnostic mode for packet tracing at 706. In diagnostic mode, the simulation unit 350 revises or inserts packets, but the packets are not transmitted by the ASIC through an external port. In addition, the simulator unit 350 only READs data from the ASIC memory in the diagnostic mode.

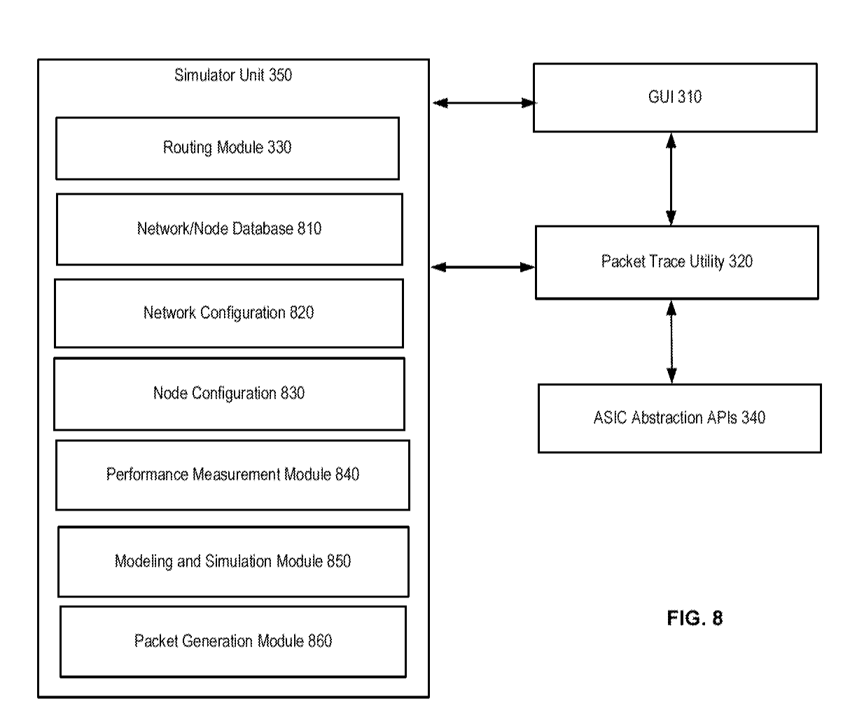

FIG. 8 illustrates a schematic block diagram of an embodiment of a simulator unit 350 in more detail. The simulator unit 350 is configured to simulate operations of an ASIC based packet processing of a node 100. In an embodiment, the simulator unit 350 includes a simulator developed for testing and lab environments, such as GNS-3® from GNS3 Technologies Inc. or Nokia VSR-SIM™. The simulator unit 350 is then used for packet tracing in an ASIC of a packet switching node deployed in a production environment. The simulator unit 350 includes a routing module 330 that includes configuration, forwarding data and simulation data for a specific network element. The simulator unit 350 may also include a network/node database 810 that includes configuration data for simulating network models and network elements. The type of data may include system image files, configuration files, hardware and software inventories, system and application log files, etc.

The network configuration 820 and node configuration 830 define network configurations and configures network components and systems respectively. The network configuration 820 and node configuration 830 are configured to generate configuration files for a domain name server (DNS), a dynamic host configuration protocol (DHCP) server, and/or VLAN definition. Performance measurement module 840 performs analysis of network traffic. Performance measurement module 840 may monitor the link status and performance between distributed nodes or within network elements.

The modeling and simulation module 850 is configured for real-time network modeling and network element simulation. By applying the configuration files, a test network and network components are configured for performing various test experiments. A packet generation module 860 controls traffic flow and injects traffic-packets into the simulated network and/or network elements. The packet generation module 860 provides control of packets injected into the network during simulations. The packet generation module 860 may receive input from the packet trace utility 320 or the GUI 310 for data or packet information to write to a packet switching ASIC for packet tracing. The simulator unit 350 may include additional functionality, such as network mapping software, asset management software, storage management software, and security management software.

The packet trace device 300 may receive input from the the GUI 310 for data or packet information for packet tracing. The packet generation module 860 generates packet or packet data to write to one or more memories/buffers/registers of the packet switching ASIC for packet tracing. The packet trace utility 320 then inserts the packet or packet data for processing by an ASIC in the node at 606. The packet trace device 300 obtains data generated by the ASIC related to processing of the packet and stored in memory of the ASIC at 608. The packet trace device 300 performs simulation of the functions of the ASIC using the data at 610. The packet trace device 300 then obtains packet tracing information from the simulation. The simulator unit 350 is thus able to use data from the actual ASIC hardware, such as data from tables/registers and provides information on where a packet is dropped or other error occurs.

As may be used herein, the term “operable to” or “configured to” indicates that an item includes one or more functions, components, input(s), output(s), etc., to perform, when activated, its described or corresponding functions and may further include direct or inferred coupling to one or more other items to perform, when activated, its described or corresponding functions. As may still further be used herein, the term “associated with”, includes direct and/or indirect association or origination or coupling of separate items and/or one item being embedded within another item.

The term “module” or “unit” is used in the description of the various embodiments of the disclosure. A “module” or “unit” indicates a device that includes or operates with one or more hardware components, such as a single processing device or a plurality of processing devices. A module or unit may also include software stored on memory for performing one or more functions as may be described herein. Note that, the hardware components of a module or unit may operate independently and/or in conjunction with software and/or firmware. As used herein, a module or unit may contain one or more sub-modules, each of which may be one or more modules. As may also be used herein, a module may include one or more additional components.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The description and figures includes functional building blocks. The boundaries and sequence of these functional building blocks may have been arbitrarily defined herein for convenience of description. Alternate boundaries and sequences can be defined so long as the specified functions and relationships are appropriately performed. Any such alternate boundaries or sequences are thus within the scope and spirit of the claims. Embodiments have been described above with the aid of method steps illustrating the performance of specified functions and relationships thereof. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

The disclosure may have also been described, at least in part, in terms of one or more embodiments. An embodiment of the disclosure is used herein to illustrate the disclosure, an aspect thereof, a feature thereof, a concept thereof, and/or an example thereof. A physical embodiment of an apparatus, an article of manufacture, a machine, and/or of a process that embodies the disclosure may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the disclosure have been expressly described herein, other combinations of these features and functions are likewise possible. The disclosure is not limited by the particular examples disclosed herein and expressly incorporates these other combinations.

What is claimed is:

1. A packet trace device, comprising:
a packet trace utility configured to communicate with a packet switching node deployed in a production network, wherein the packet trace utility receives data related to processing of packets stored by a packet switching ASIC in the node;
a simulator unit configured to:
simulate functions of the packet switching ASIC using the data from the node; and
obtain packet tracing information from the simulation.

2. The packet trace device of claim 1, wherein the packet trace device further comprises:
an ASIC abstraction application programming interface (API) configured to map to a memory of the packet switching ASIC in the node and obtain the data related to processing of packets generated by the packet switching ASIC.

3. The packet trace device of claim 2, wherein the ASIC abstraction API is configured to obtain data from hardware memory tables generated by the packet switching ASIC.

4. The packet trace device of claim 1, wherein the simulator unit is configured to operate in a diagnostics mode.

5. The packet trace device of claim 4, wherein the simulator unit operating in the diagnostics mode is configured to:
simulate packet processing of the packet switching ASIC using data from hardware memory tables of the packet switching ASIC; and
provide one or more log messages on the simulated packet processing at each block of the packet switching ASIC.

6. The packet trace device of claim 1, further comprising:
a routing module configured to simulate forwarding functions of the packet switching ASIC in the node.

7. The packet trace device of claim 1, further comprising:
a packet generation module for generating packet or packet data to write to one or more memories of the packet switching ASIC.

8. A method for packet tracing, comprising:
accessing a packet switching ASIC in a node, wherein the node is deployed in the production network;
obtaining data stored in a memory by the packet switching ASIC;
simulating functions of the packet switching ASIC using the obtained data from the packet switching ASIC; and
generating packet tracing information from simulating the functions.

9. The method for packet tracing of claim 8, further comprising:
mapping to the memory in the packet switching ASIC using an ASIC abstraction application programming interface (API) to obtain the data.

10. The method for packet tracing of claim 9, further comprising:
operating in a diagnostics mode to simulate functions of the packet switching ASIC.

11. The method of claim 10, comprising:
simulating packet processing of the packet switching ASIC using data from hardware memory tables of the packet switching ASIC; and
providing one or more log messages on the simulated packet processing at each block of the packet switching ASIC.

12. The method of claim 8, comprising:
simulating forwarding functions of the packet switching ASIC in the node.

13. The method of claim 12, comprising:
generating packet or packet data; and
writing the packet or packet data to one or more memories of the packet switching ASIC.

14. The method of claim 13, comprising:
generating the packet tracing information from the simulation of the forwarding functions using the obtained data from the packet switching ASIC.

15. A network management system, comprising:
a network interface coupled to a plurality of packet switching nodes in a production network;
a packet trace device, including:
a packet trace utility configured to communicate with at least one of the plurality of packet switching nodes, wherein the packet trace utility receives data related to processing of packets stored by a packet switching ASIC in the node; and
a simulator unit configured to simulate functions of the packet switching ASIC using the data from the node and obtain packet tracing information from the simulation.

16. The network management system of claim 15, wherein the network management system further comprises:
an ASIC abstraction application programming interface (API) configured to map to a memory of the packet switching ASIC in the node and obtain the data related to processing of packets generated by the packet switching ASIC.

17. The network management system of claim 16, wherein the ASIC abstraction API is configured to obtain data from hardware memory tables generated by the packet switching ASIC.

18. The network management system of claim 15, wherein the simulator unit is configured to operate in a diagnostics mode.

19. The network management system of claim 18, wherein the simulator unit operating in the diagnostics mode is configured to:
simulate packet processing of the packet switching ASIC using data from hardware memory tables of the packet switching ASIC; and
provide one or more log messages on the simulated packet processing at each block of the packet switching ASIC.

20. The network management system of claim 15, further comprising:
a routing module configured to simulate forwarding functions of the packet switching ASIC in the node; and
a packet generation module for generating packet or packet data to write to one or more memories of the packet switching ASIC.
